(19) United States
(12) Patent Application Publication
(10) Pub. No.: US 2024/0399756 A1
(43) Pub. Date: Dec. 5, 2024

(54) INK SUPPLYING MECHANISM AND IMAGE FORMING APPARATUS

(71) Applicant: KYOCERA Document Solutions Inc., Osaka (JP)

(72) Inventor: Shinya SAKAOKA, Osaka (JP)

(73) Assignee: KYOCERA Document Solutions Inc., Osaka (JP)

(21) Appl. No.: 18/731,169

(22) Filed: May 31, 2024

(30) Foreign Application Priority Data
Jun. 5, 2023 (JP) 2023-092248

(51) Int. Cl. B41J 2/19; B41J 2/175; B41J 2/18

(52) U.S. Cl. CPC B41J 2/19; B41J 2/17596; B41J 2/18

(57) ABSTRACT

An ink supplying mechanism includes an ink container containing ink, an ink tank storing the ink supplied from the ink container to a recording head, a decompressing part decompressing the ink tank and a degassing channel circulating the ink flowed out from the ink tank and flowing the ink into the ink tank. To the recording head, the ink tanks are arranged in parallel. When one ink tank among the ink tanks is used for printing, a degassing tank to be degassed is selected from other ink tanks, whose dissolved oxygen amount of the ink have not arrived a predetermined supplying target value, according to predetermined degassing selection criteria, and the ink inside the degassing tank is circulated by using the degassing channel, in a state that the degassing tank is decompressed by the decompressing part, to perform degassing operation of degassing the ink inside the degassing tank.

### INCORPORATION BY REFERENCE

This application is based on and claims the benefit of priority from Japanese Patent application No. 2023-092248 filed on Jun. 5, 2023, the entire contents of which are incorporated herein by reference.

### BACKGROUND

The present disclosure relates to an ink supplying mechanism and an image forming apparatus for printing by discharging ink from a recording head.

Conventionally, an inkjet type image forming apparatus is equipped with a recording head having nozzles that discharge ink droplets onto a recording medium such as paper, an ink container that contains ink, and an ink tank that stores ink supplied from the ink container, and uses hydraulic head pressure between the ink tank and the recording head to supply ink to the recording head. In the image forming apparatus, if the ink contains air bubbles, the nozzles become clogged with air bubbles, resulting in poor ejection performance. Since the liquid surface of the ink tends to dissolve in contact with air in the ink tank, it is necessary to control an amount of dissolved air in the ink supplied to the recording head.

For example, some conventional image forming apparatuses apply a method of degassing ink by passing ink through a hollow fiber filter. However, this method requires the use of expensive hollow-fiber filters for each color of ink and the periodic replacement of each hollow-fiber filter, resulting in high costs for ink degassing.

Conventional deaerator that removes air dissolved in ink used in an inkjet printer is equipped with a pump that decompress the inside of an ink bottle containing ink to −80 kPa or less and a magnetic field generator that generates a magnetic field. The ink bottle accommodates, in the ink, a magnetic rotor that rotates in response to changes in the external magnetic field. The magnetic field generator applies a magnetic field from outside the ink bottle to the magnet rotor to cause the magnet rotor to rotate. As a result, the magnetic field generator agitates the ink in the ink bottle, and the ink in the ink bottle, which is decompressed by the pump, is agitated by the rotation of the magnet rotor, thereby degassing the air in the ink.

Conventional inkjet recorder is equipped with a recording head that discharges ink, a tank that contains ink supplied to the recording head, and a floating body that floats on the liquid surface of the ink in the tank. The floating body has a bottom side in contact with the ink that is inclined toward the liquid surface, which is the boundary between the ink and air. The ink is agitated under decompression to prevent re-melting of air into the degassed ink.

In conventional image forming apparatus, as described above, a method of degassing ink in a decompressed ink tank by agitating the ink with a magnetic agitator (agitating degassing method) is applied to improve degassing efficiency by agitating the degassed ink near the liquid surface in the ink tank. However, since the agitator is located at the bottom of the ink tank, if the ink filling depth in the ink tank is increased, the ink replacement performance is reduced between the ink near the liquid surface, where there is little dissolved air, and the ink near the bottom, where there is much dissolved air. Therefore, it is difficult to increase the ink filling volume in the ink tank. By contrast, some conventional image forming apparatuses apply a method to increase the agitation efficiency by increasing the rotation speed of the agitator. However, if the agitator is rotated excessively high, the agitator is not constrained by external magnetism and agitation is not properly performed, which may result in poor degassing performance.

### SUMMARY

An ink supplying mechanism in accordance with the present disclosure includes an ink container, an ink tank, a decompressing part and a degassing channel. The ink container contains ink. The ink tank stores the ink supplied from the ink container to a recording head. The decompressing part decompresses the inside of the ink tank. The degassing channel circulates the ink flowed out from the ink tank and flowing the ink into the ink tank. to the recording head, a plurality of the ink tanks are arranged in parallel. When one ink tank among the plurality of ink tanks is used for printing, a degassing tank to be degassed is selected from other ink tanks, whose dissolved oxygen amount of the ink have not arrived a predetermined supplying target value, according to predetermined degassing selection criteria, and the ink inside the degassing tank is circulated by using the degassing channel, in a state that the inside of the degassing tank is decompressed by the decompressing part, to perform degassing operation of degassing the ink inside the degassing tank.

An image forming apparatus in accordance with the present disclosure includes the ink supplying mechanism as described above.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a cross-sectional view schematically showing an example of a printer in accordance with one embodiment of the present disclosure.

FIG. 2 is a block diagram schematically showing an example of the ink supplying mechanism of the printer in accordance with one embodiment of the present disclosure.

FIG. 3 is a graph showing an example of time variation of a dissolved oxygen amount of ink during degassing of the ink tank in an ink supplying mechanism.

FIG. 4 is a flowchart showing an example of operation of degassing tank selection of the ink supplying mechanism of the printer according to an embodiment of the present disclosure.

FIG. 5 is a flowchart showing an example of operation of switching tank selection of the ink supplying mechanism of the printer according to an embodiment of the present disclosure.

### BRIEF DESCRIPTION OF THE INVENTION

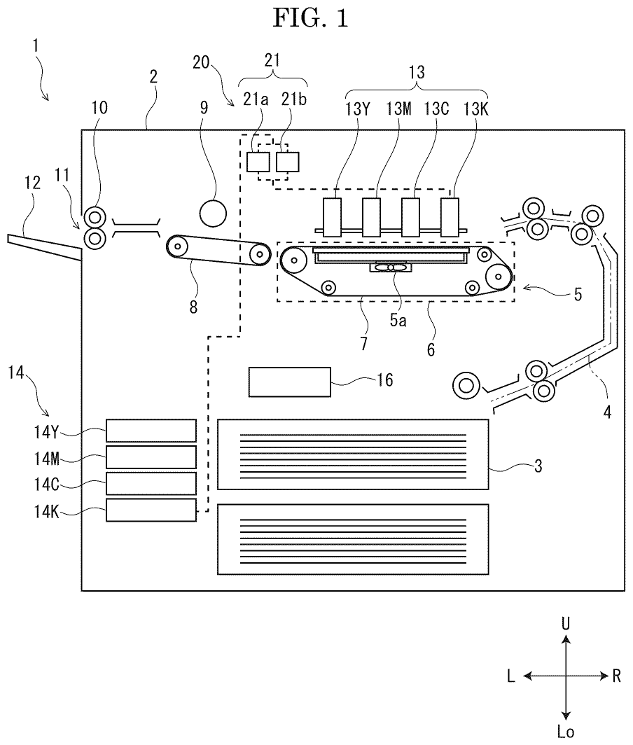

First, the overall configuration of a printer 1 as an inkjet type image forming apparatus will be described with reference to FIG. 1. For convenience of explanation, it will be described so that the front side of the printer 1 is positioned at a near side on a paper sheet of FIG. 1. The arrows L, R, U, and Lo, which are attached to each figure as appropriate, indicate the left side, right side, upper side, and lower side of the printer 1, respectively.

As shown in FIG. 1, the printer 1 includes a box-shape printer body 2. In a lower part of the printer body 2, a sheet feeding cartridge 3 storing sheets is drawably housed.

In a right part inside the printer body 2, a conveyance path 4 of the sheet is arranged and, in a center part inside the printer body 2, the sheet conveying unit 5 is ascendably/descendably arranged above the sheet feeding cartridge 3. The conveyance path 4 is provided from the sheet feeding cartridge 3 to the sheet conveying unit 5 and, along a conveying direction of the sheet through the conveyance path 4, a sheet feeding roller, a conveying roller and a registration roller are located in sequential order from an upstream side.

The sheet conveying unit 5 includes a conveying frame 6 and an endless conveying belt 7 (a conveying member) To the conveying frame 6, a driving roller, a following roller and a tensioning roller are rotatably arranged, and the conveying belt 7 is interchangeably attached to the conveying frame 6 and wound around the drive roller, the following roller, and the tensioning roller. The conveying belt 7 is controlled by a controlling part 16 described below so as to rotate, for example, counterclockwise in the front view, in response to the rotation of the drive roller, and to convey the paper on the conveying belt 7 from the right side to the left side.

The sheet conveying unit 5 is equipped with a lifting mechanism (not shown) that can ascent and descent the conveying frame 6 and the conveying belt 7 in upward and downward directions, and moves the conveying frame 6 and the conveying belt 7 between a print position close to recording heads 13 described below in printing operation and an evacuation position separate from the recording heads 13 in non-printing operation. The sheet conveying unit 5 is also equipped with an air suction part 5a inside the conveying belt 7. The conveying belt 7 is provided with a lot of air suction holes, and the air suction part 5a sucks air from above the conveying belt 7 to the inside via the air suction holes.

In the left part of the printer body 2, a sheet conveying part 8, a drying device 9, and an ejecting roller 10 are provided to the left side of the sheet conveying unit 5 that is at the printing position in order to eject the sheet after printing. On the left side face of the printer body 2, an ejecting port 11 is formed near the ejecting roller 10, and an ejected sheet tray 12 protruding to the left side is provided below the ejecting port 11.

Moreover, inside the printer body 2, four recording heads 13 (13K, 13C, 13M, 13Y) that discharge ink corresponding to the four ink colors of black, cyan, magenta, and yellow, respectively, and four ink containers 14 (14K, 14C, 14M, 14Y) that contain ink are provided. Each recording head 13 is connected to each ink container 14 via an ink supplying mechanism 20 having a plurality of ink tanks 21 (sub-tanks). Incidentally, in FIG. 1, the ink supplying mechanism 20 corresponding to black ink is illustrated, and the ink supplying mechanisms 20 corresponding to cyan, magenta, and yellow ink are omitted.

On lower faces of the recording heads 13K, 13C, 13M, 13Y, a plurality of nozzles 13a for discharging ink droplets are formed. The recording heads 13K, 13C, 13M, 13Y are arranged in a line above the sheet conveying unit 5 at the center in the printer body 2, for example, arranged in sequential order from an upstream side (right side) in the conveying direction of the sheet. The recording heads 13K, 13C, 13M, and 13Y face a top face of the conveying belt 7 of the sheet conveying unit 5 during printing operation and discharge black, cyan, magenta, and yellow inks, respectively, onto the sheet on the conveying belt 7.

The ink containers 14K, 14C, 14M, and 14Y are arranged in a line side-by-side in a lower left section of the printer body 2, for example, arranged in sequential order from a lower side. The ink containers 14K, 14C, 14M, and 14Y are, for example, attachably/detachably housed in respective container housing sections (not shown) provided in the lower left section in the printer body 2. The ink containers 14K, 14C, 14M, and 14Y accommodate black, cyan, magenta, and yellow inks, respectively.

Inside the printer body 2, a controlling part 16 is provided to control each part of the printer 1. The controlling part 16 is a computer composed of a central processing unit (CPU) or the like, and controls each part of the printer 1 connected to the controlling part 16 by executing arithmetic process on the basis of control programs and control data stored in a storing part (not shown) composed of ROM, RAM, HDD, or the like.

The controlling part 16 controls the refilling operation, degassing operation, supplying operation, and circulating operation described below in the ink supplying mechanism 20. When printing, the controlling part 16 performs the supplying operation to supply ink from one ink tank 21 used for printing (hereinafter referred to as “print use tank”), among the plurality of ink tanks 21, to the recording head 13, and, at the same time, performs the refilling operation and the degassing operation as preparation for the other ink tank 21 other than the print use tank.

In this embodiment, in particular, the controlling part 16 selects a degassing tank to be degassed from the other ink tanks 21 (hereinafter referred to as standby tank) other than the print use tank, whose dissolved oxygen amount of the ink has not arrived a predetermined supplying target value, according to predetermined degassing selection criteria, and performs the degassing operation on the degassing tank. The controlling part 16 also selects a switching tank to be next switched from the other ink tanks 21 other than the print use tank, which has a dissolved oxygen amount of the ink not arrived a predetermined supplying target value, whose dissolved oxygen amount of the ink has arrived the predetermined supplying target value, according to predetermined switching selection criteria. Details of control of the refilling operation, the degassing operation, the supplying operation, and circulation operation of the ink supplying mechanism 20 by the controlling part 16 and details of degassing tank selection and switching tank selection are described below.

Next, the details of the ink supplying mechanism 20 will be described.

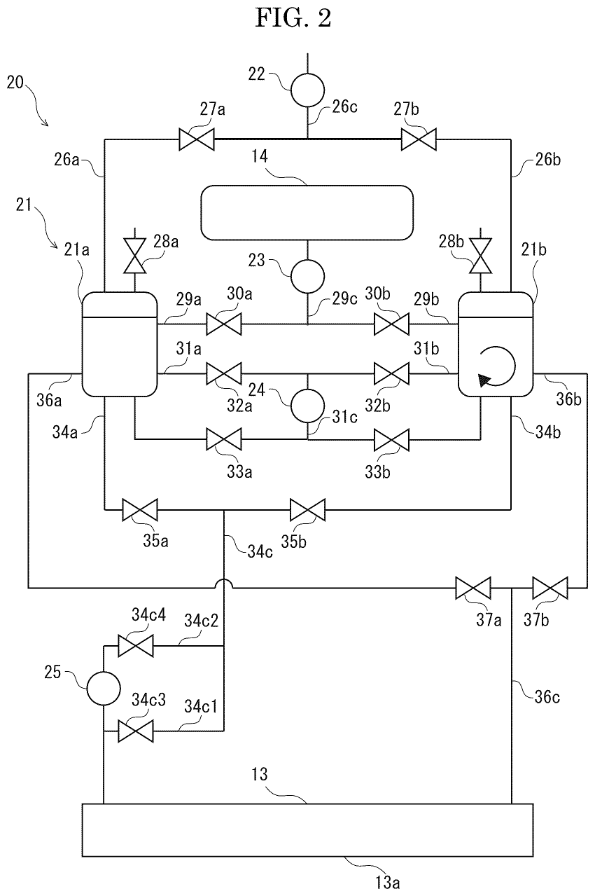

The ink supplying mechanism 20 is a mechanism for supplying the ink from each ink container 14 (14K, 14C, 14M, 14Y) to each recording head 13 (13K, 13C, 13M, 13Y). In the embodiment, as shown in FIG. 2, the ink supplying mechanism 20 is equipped with the plurality of ink tanks 21, a decompression pump 22, a suction pump 23, a degassing pump 24, and a circulation pump 25, in addition to the recording heads 13 and the ink containers 14.

The ink supplying mechanism 20 is equipped with, for example, a first ink tank 21a and a second ink tank 21b as the plurality of ink tanks 21 that store the ink supplied from the ink containers 14. The ink supplying mechanism 20 is configured to supply the ink toward the recording heads 13 using the hydraulic head pressure of the ink stored in the first ink tank 21a and the second ink tank 21b. Incidentally, although the embodiment describes an example in which the ink supplying mechanism 20 is provided with two ink tanks 21 (the first ink tank 21a and the second ink tank 21b), the present disclosure is not limited to this example, and the ink supplying mechanism 20 may be provided with three or more ink tanks 21.

The ink supplying mechanism 20 has, as decompression channels for decompressing the inside of the ink tanks 21, a first decompression channel 26a connected to the first ink tank 21a to communicate with the internal space above the ink liquid level, and a second decompression channel 26b connected to the second ink tank 21b to communicate with the internal space above the ink liquid level. Upstream portions of the first decompression channel 26a and the second decompression channel 26b are partially common as a common decompression channel 26c, and the decompression pump 22 is provided in the common decompression channel 26c.

The first decompression channel 26a and the decompression pump 22 function as the decompressing part of the first ink tank 21a, and the second decompression channel 26b and the decompression pump 22 function as the decompression portion of the second ink tank 21b. The decompression pump 22 is a negative pressure generator that is controlled by the controlling part 16 to decompress the inside of the first ink tank 21a and the second ink tank 21b. In the first decompression channel 26a, a first decompression valve 27a is provided to open and close the first decompression channel 26a, and, in the second decompression channel 26b, a second decompression valve 27b is provided to open and close the second decompression channel 26b. The first decompression valve 27a and the second decompression valve 27b are controlled by the controlling part 16 to open and close.

Moreover, in the first ink tank 21a, a first atmosphere valve 28a is provided to open and close communication between the first ink tank 21a and the atmosphere, and, in the second ink tank 21b, a second atmosphere valve 28b is provided to open and close communication between the second ink tank 21b and the atmosphere. The first atmosphere valve 28a and the second atmosphere valve 28b are controlled by the controlling part 16 to open and close.

The ink supplying mechanism 20 has a first suction channel 29a for sucking the ink from the ink container 14 to the first ink tank 21a and a second suction channel 29b for sucking the ink from the ink container 14 to the second ink tank 21b. Upstream portions of the first suction channel 29a and the second suction channel 29b are partially common as a common suction channel 29c, and the suction pump 23 is provided in the common suction channel 29c.

The suction pump 23 is composed of a diaphragm pump or the like, and is controlled by the controlling part 16 to supply the ink from the ink container 14 to the first ink tank 21a and the second ink tank 21b via the first suction channel 29a and the second suction channel 29b. In a downstream portion of the first suction channel 29a, a first suction valve 30a is provided to open and close the first suction channel 29a, and, in a downstream portion of the second suction channel 29b, a second suction valve 30b is provided to open and close the second suction channel 29b. The first suction valve 30a and the second suction valve 30b are controlled by the controlling part 16 to open and close.

The ink supplying mechanism 20 has a first degassing channel 31a circulated to the first ink tank 21a and a second degassing channel 31b circulated to the second ink tank 21b as degassing channels for circulating the ink flowed out from the ink tank 21 and flowed into the ink tank 21. Midstream portions of the first degassing channel 31a and the second degassing channel 31b are partially common as a common degassing channel 31c, and the degassing pump 24 is provided in the common degassing channel 31c.

The degassing pump 24 is controlled by the controlling part 16 to cause the ink stored in the first ink tank 21a and the second ink tank 21b to flow out into the first degassing channel 31a and the second degassing channel 31b, and to cause the ink flowing out into the first degassing channel 31a and the second degassing channel 31b to flow into the first ink tank 21a and the second ink tank 21b, thereby circulating and degassing the ink stored in the first ink tank 21a and the second ink tank 21b. In upstream and downstream portions of the first degassing channel 31a, first degassing valves 32a and 33a are provided to open and close the first degassing channel 31a, and, in upstream and downstream portions of the second degassing channel 31b, second degassing valves 32b and 33b are provided to open and close the second degassing channel 31b. The first degassing valves 32a and 33a and the second degassing valves 32b and 33b are controlled by the controlling part 16 to open and close.

The ink supplying mechanism 20 has a first supplying channel 34a that supplies the ink from the first ink tank 21a to the recording head 13 and a second supplying channel 34b that supplies the ink from the second ink tank 21b to the recording head 13. Downstream portions of the first supplying channel 34a and the second supplying channel 34b are partially common as a common supplying channel 34c, and the common supplying channel 34c is connected to the recording head 13.

The first supplying channel 34a and the second supplying channel 34b are subjected to the hydraulic head pressure of the ink stored in the first ink tank 21a and the second ink tank 21b in order to supply ink toward the recording head 13. In an upstream portion of the first supplying channel 34a, a first supplying valve 35a is provided to open and close the first supplying channel 34a, and, in an upstream portion of the second supplying channel 34b, a second supplying valve 35b is provided to open and close the second supplying channel 34b. The first supplying valve 35a and the second supplying valve 35b are controlled by the controlling part 16 to open and close.

Incidentally, a middle portion of the common supplying channel 34c is branched into a supplying branch channel 34cl used for ink supplying and a circulation branch channel 34c2 used for ink circulation, and the circulation pump 25 is provided in the circulation branch channel 34c2. The circulation pump 25 is controlled by the controlling part 16 to supply the ink to the recording head 13 via the circulation branch path 34c2 in order to circulate the ink remaining in the recording head 13. In the supplying branch channel 34c1, a supplying branch valve 34c3 is provided to open and close the supplying branch path 34c1, and, in the circulation branch path 34c2, a circulation branch valve 34c4 is provided to open and close the circulation branch path 34c2. The supplying branch valves 34c3 and the circulation branch valve 34c4 are controlled by the controlling part 16 to open and close.

The ink supplying mechanism 20 has a first circulation channel 36a circulating the ink from the recording head 13 to the first ink tank 21a and a second circulation channel 36b circulating the ink from the recording head 13 to the second ink tank 21b. Upstream portions of the first circulation channel 36a and the second circulation channel 36b are partially common as a common circulation channel 36c, and the common circulation channel 36c is connected to the recording head 13. In a downstream portion of the first circulation channel 36a, a first circulation valve 37a is provided to open and close the first circulation channel 36a, and, in a downstream portion of the second circulation channel 36b, a second circulation valve 37b is provided to open and close the second circulation channel 36b. The first circulation valve 37a and the second circulation valve 37b are controlled by the controlling part 16 to open and close.

### <Example of Operation of Ink Supplying Mechanism>

Next, an example of operation of the ink supplying mechanism 20 of the embodiment will be described.

### <Refilling Operation>

The ink supplying mechanism 20 performs either a first refilling operation to refill the ink from the ink container 14 to the first ink tank 21a or a second refilling operation to refill the ink from the ink container 14 to the second ink tank 21b.

When performing the first refilling operation, the ink supplying mechanism 20 opens the first atmosphere valve 28a and the first suction valve 30a for the first ink tank 21a, and works the suction pump 23 to refill the ink from the ink container 14 to the first ink tank 21a via the first suction channel 29a. At this time, the ink supplying mechanism 20 closes the second suction valve 30b for the second ink tank 21b, and closes the first decompression valve 27a, first degassing valves 32a and 33a, first supplying valve 35a and first circulation valve 37a for the first ink tank 21a.

During the first refilling operation, the supplying branch valve 34c3 and the circulation branch valves 34c4, as well as the decompression pump 22, the degassing pump 24 and the circulation pump 25 can be used for second degassing operation, the second supplying operation and second circulation operation of the second ink tank 21b. In other words, the ink supplying mechanism 20 can print by the second supplying operation using the second ink tank 21b while the first refilling operation of the first ink tank 21a is being performed.

When performing the second refilling operation, the ink supplying mechanism 20 opens the second atmosphere valve 28b and the second suction valve 30b for the second ink tank 21b and works the suction pump 23 to supply the ink from the ink container 14 to the second ink tank 21b via the second suction channel 29b. At this time, the ink supplying mechanism 20 closes the first suction valve 30a for the first ink tank 21a, and closes the second decompression valve 27b, the second degassing valves 32b and 33b, the second supplying valve 35b and the second circulation valve 37b for the second ink tank 21b.

Incidentally, during the second filling operation, the supplying branch valve 34c3 and the circulation branch valve 34c4, as well as the decompression pump 22, the degassing pump 24 and the circulation pump 25 can be used for first degassing operation, the first supplying operation and first circulation operation of the first ink tank 21a. In other words, the ink supplying mechanism 20 can print by the first supplying operation using the first ink tank 21a while the second refilling operation of the second ink tank 21b is being performed.

### <Degassing Operation>

The ink supplying mechanism 20 performs either the first degassing operation to degas the ink stored in the first ink tank 21a or the second degassing operation to degas the ink stored in the second ink tank 21b.

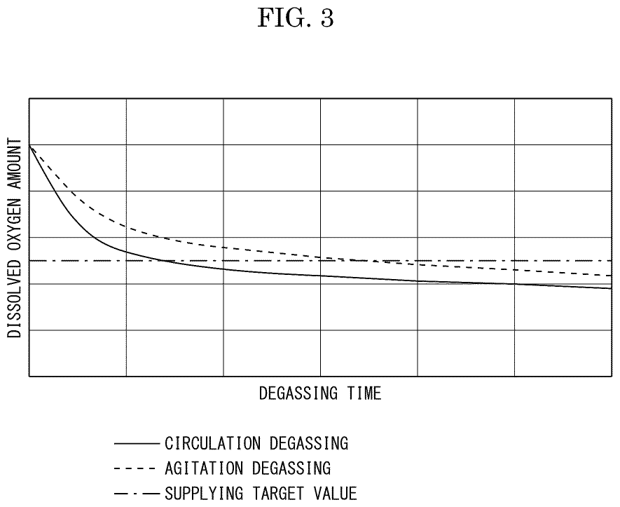

By the way, as a method of degassing the air dissolved in the ink stored in the ink tank 21, agitation degassing method, in which an agitating device is provided in the ink tank 21 and the ink stored in the ink tank 21 is agitated to degas the ink, has been conventionally applied. In contrast, the present disclosure applies circulating degassing method, in which the ink stored in ink tank 21 is flowed out and the flowed ink is circulated to flow back into the ink tank 21, thereby creating a flow over the entire ink in ink tank 21 and agitating the ink to degas the ink. FIG. 3 shows a graph of time variation of the dissolved oxygen amount of the ink when the ink tank 21 is degassed by both the agitation degassing method and the circulation degassing method. As shown in FIG. 3, in comparison with the agitation degassing method, the circulation degassing method takes less time for the dissolved oxygen amount of the ink to arrive the predetermined supplying target value.

When performing the first degassing operation, the ink supplying mechanism 20 closes the first atmosphere valve 28a, the first suction valve 30a, the first degassing valves 32a and 33a, the first supplying valve 35a, and the first circulation valve 37a for the first ink tank 21a, and opens the first decompression valve 27a. Furthermore, the ink supplying mechanism 20 works the decompression pump 22 to decompress the inside of the first ink tank 21a via the first decompression channel 26a. At this time, the ink supplying mechanism 20 closes the second decompression valve 27b to the second ink tank 21b. In a state that the inside of the first ink tank 21a is decompressed, the ink supplying mechanism 20 opens the first degassing valves 32a and 33a to the first ink tank 21a and works the degassing pump 24 to degas the ink stored in the first ink tank 21a via the first degassing channel 31a. At this time, the ink supplying mechanism 20 closes the second degassing valves 32b and 33b for the second ink tank 21b, and closes the first decompression valve 27a, the first atmosphere valve 28a and the first suction valve 30a, the first supplying valve 35a and the first circulation valve 37a for the first ink tank 21a.

During the first degassing operation, the supplying branch valve 34c3 and the circulation branch valve 34c4, as well as the suction pump 23 and the circulation pump 25 can be used for the second refilling operation, the second supplying operation and the second circulation operation of the second ink tank 21b. In other words, the ink supplying mechanism 20 can print by the second supplying operation using the second ink tank 21b while the first degassing operation of the first ink tank 21a is being performed.

When performing the second degassing operation, the ink supplying mechanism 20 closes the second atmosphere valve 28b, the second suction valve 30b, the second degassing valves 32b and 33b, the second supplying valve 35b, and the second circulation valve 37b for the second ink tank 21b, and also opens the second decompression valve 27b. Furthermore, the ink supplying mechanism 20 works the decompression pump 22 to decompress the inside of the second ink tank 21b via the second decompression channel 26b. At this time, the ink supplying mechanism 20 closes the first decompression valve 27a to the first ink tank 21a. Then, in a state that the inside of the second ink tank 21b is decompressed, the ink supplying mechanism 20 opens the degassing valves 32b and 33b for the second ink tank 21b, and works the degassing pump 24 to degas the ink stored in the second ink tank 21b via the second degassing channel 31b. At this time, the ink supplying mechanism 20 closes the first degassing valves 32a and 33a for the first ink tank 21a, and closes the second decompression valve 27b, the second atmosphere valve 28b and the second suction valve 30b, the second supplying valve 35b and the second circulation valve 37b for the second ink tank 21b.

During the second degassing operation, the supply branch valve 34c3 and the circulation branch valve 34c4, as well as the suction pump 23 and the circulation pump 25 can be used for the first refilling operation, the first supplying operation and the first circulation operation of the first ink tank 21a. In other words, the ink supplying mechanism 20 can print by the first supplying operation using the first ink tank 21a while the second degassing operation of the second ink tank 21b is being performed.

### <Supplying Operation>

When printing by the recording head 13, the ink supplying mechanism 20 performs either a first supplying operation to supply the ink from the first ink tank 21a to the recording head 13 or a second supplying operation to supply the ink from the second ink tank 21b to the recording head 13.

When performing the first supplying operation, the ink supplying mechanism 20 opens the first atmosphere valve 28a, the first supplying valve 35a, and the supplying branch valve 34c3 for the first ink tank 21a, and supplies the ink from the first ink tank 21a to the recording head 13 via the first supplying channel 34a passing through the supplying branch channel 34c1. At this time, the ink supplying mechanism 20 closes the second supplying valve 35b for the second ink tank 21b, closes the first decompression valve 27a, the first suction valve 30a, the first degassing valves 32a and 33a, the circulation branch valve 34c4 and the first circulation valve 37a for the first ink tank 21a, and stops working of the circulation pump 25.

While the first supplying operation is being performed, the decompression pump 22, the suction pump 23 and the degassing pump 24 can be used for the second refilling operation and the second degassing operation and others of the second ink tank 21b. In other words, the ink supplying mechanism 20 can perform the second refilling operation and the second degassing operation of the second ink tank 21b while printing is being performed by the first supplying operation using the first ink tank 21a.

When performing the second supplying operation, the ink supplying mechanism 20 opens the second atmosphere valve 28b, the second supplying valve 35b, and the supplying branch valve 34c3 for the second ink tank 21b, and supplies the ink from the second ink tank 21b to the recording head 13 via the second supplying channel 34b passing through the supplying branch channel 34c1. At this time, the ink supplying mechanism 20 closes the first supplying valve 35a for the first ink tank 21a, closes the second decompression valve 27b, the second suction valve 30b, the second degassing valves 32b and 33b, the circulation branch valve 34c4 and the second circulation valve 37b for the second ink tank 21b, and stops working of the circulation pump 25.

While the second supplying operation is being performed, the decompression pump 22, the suction pump 23 and the degassing pump 24 can be used for the first refilling operation and the first degassing operation and others of the first ink tank 21a. In other words, the ink supplying mechanism 20 can perform the first refilling operation and the first degassing operation of the first ink tank 21a while printing is being performed by the second supplying operation using the second ink tank 21b.

### <Circulation Operation>

The ink supplying mechanism 20 performs either the first circulation operation to circulate ink from the recording head 13 to the first ink tank 21a or the second circulation operation to circulate ink from the recording head 13 to the second ink tank 21b.

When performing the first circulation operation, the ink supplying mechanism 20 opens the first atmosphere valve 28a, the first supplying valve 35a, the circulation branch valve 34c4, and the first circulation valve 37a for the first ink tank 21a. Furthermore, the ink supplying mechanism 20 works the circulation pump 25 to supply the ink from the first ink tank 21a to the recording head 13 via the first supplying channel 34a passing through the circulation branch channel 34c2 and to collect the ink from the recording head 13 to the first ink tank 21a via the first circulation channel 36a, thereby circulating the ink from the recording head 13 to the first ink tank 21a. At this time, the ink supplying mechanism 20 closes the second supplying valve 35b and the second circulation valve 37b for the second ink tank 21b, and closes the first decompression valve 27a, the first suction valve 30a, the first degassing valves 32a and 33a and the supplying branch valve 34c3 for the first ink tank 21a.

During the first circulation operation, the decompression pump 22, the suction pump 23 and the degassing pump 24 can be used for the second refilling operation and the second degassing operation and others of the second ink tank 21b.

When the second circulation operation is performed, the ink supplying mechanism 20 opens the second atmosphere valve 28b, the second supplying valve 35b, the circulation branch valve 34c4 and the second circulation valve 37b for the second ink tank 21b. Furthermore, the ink supplying mechanism 20 works the circulation pump 25 to supply the ink from the second ink tank 21b to the recording head 13 via the second supplying channel 34b passing through the circulation branch channel 34c2 and to collect the ink from the recording head 13 to the second ink tank 21b via the second circulation channel 36b, thereby circulating the ink from the recording head 13 to the second ink tank 21b. At this time, the ink supplying mechanism 20 closes the first supplying valve 35a and the first circulation valve 37a for the first ink tank 21a, and closes the second decompression valve 27b, the second suction valve 30b, the second degassing valves 32b and 33b and the supplying branch valve 34c3 for the second ink tank 21b.

During the second circulation operation, the decompression pump 22, the suction pump 23 and the degassing pump 24 can be used for the first refilling operation and the first degassing operation and others of the first ink tank 21a.

### <Measurement of Ink Remaining Amount>

Next, measurement of an ink remaining amount in ink tank 21 by the controlling part 16 will be described. The controlling part 16 measures the ink remaining amount in the ink tank 21 by prediction and/or actual measurement.

The controlling part 16 may acquire predictive information on the ink remaining amount as described below, and predict the ink remaining amount in the first ink tank 21a and the second ink tank 21b on the basis of at least one of the predictive information on the ink remaining amount.

For example, the controlling part 16 detects an outflow amount of the ink flowed out from the first ink tank 21a and the second ink tank 21b through the first supplying channel 34a and the second supplying channel 34b by flow amount sensors provided in the first supplying channel 34a and the second supplying channel 34b as the prediction information of the ink remaining amount. The controlling part 16 may then predict the ink remaining amount in the first ink tank 21a and the second ink tank 21b on the basis of the detected outflow amount of the ink from the first ink tank 21a and the second ink tank 21b.

Alternatively, the controlling part 16 calculates the ink used amount for printing on the basis of print settings, such as print density, and image data to be printed, in particular, the ink used amount for each of the first ink tank 21a and the second ink tank 21b, as the prediction information of the ink remaining amount. The controlling part 16 may then predict the ink remaining amount in the first ink tank 21a and the second ink tank 21b on the basis of calculation result of the ink used amount.

Alternatively, the controlling part 16 may predict the ink remaining amount in the first ink tank 21a and the second ink tank 21b at the present time by calculating the ink used amount of print jobs completed up to the present time. The controlling part 16 can also predict the ink remaining amount in the first ink tank 21a and the second ink tank 21b at the time of completion of next print job by calculating the ink used amount of the print job completed up to the present time and the ink used amount of the next print job.

When actually measuring the ink remaining amount in ink tank 21, the controlling part 16 detects the ink remaining amount or a free capacity of the first ink tank 21a and the second ink tank 21b by ink remaining amount sensors provided in the first ink tank 21a and the second ink tank 21b, and the controlling part 16 actually measures the ink remaining amount in the ink tank 21 on the basis of detection results. Incidentally, as the ink remaining amount sensor, any type of sensor, such as optical type, capacitance type, electrode type, differential pressure type, float type and others may be applied.

Incidentally, the controlling part 16 may use either predicted result or actual measurement result of the ink remaining amount in the first ink tank 21a and the second ink tank 21b as the measurement result, or a combination of the predicted result and the actual measurement result as the measurement result.

### <Measurement of Dissolved Oxygen Amount of Ink>

Next, the measurement of the dissolved oxygen amount of the ink in the ink tank 21 by the controlling part 16 will be described. The controlling part 16 measures the dissolved oxygen amount of the ink in the ink tank 21 by prediction and/or actual measurement.

The controlling part 16 may acquire predictive information of the dissolved oxygen amount of the ink as described below, and predict the dissolved oxygen amount of the ink in the first ink tank 21a and the second ink tank 21b on the basis of at least one of the predictive information of the dissolved oxygen amount of the ink.

For example, the controlling part 16 detects the environmental temperature and environmental air pressure of installation environment of the printer 1 by a temperature sensor and an air pressure sensor provided in the printer 1 as the predictive information of the dissolved oxygen amount of the ink. The controlling part 16 also measures elapsed time from the end of ink refilling in the first ink tank 21a and the second ink tank 21b as predictive information of the dissolved oxygen amount of the ink. Moreover, as the predictive information of the dissolved oxygen amount of the ink, the controlling part 16 calculates the ink used amount for printing on the basis of print settings, such as print density, and image data to be printed, and in particular, the ink used amount for each of the first ink tank 21a and the second ink tank 21b.

For example, when the environmental temperature is low (less than a predetermined temperature threshold) and the environmental air pressure is low (less than a predetermined air pressure threshold), because a saturated dissolved oxygen amount becomes low, the controlling part 16 predicts that the dissolved oxygen amount of the ink is low. Since the first ink tank 21a and the second ink tank 21b are refilled with degassed ink from the ink container 14, if the elapsed time from the end of ink refilling is short (less than the predetermined time threshold), the controlling part 16 predicts that the dissolved oxygen amount of the ink is low. When the print density is large (the predetermined concentration threshold or more) or the print volume in the image data is large (the predetermined print volume threshold or more), since supplying of the degassed ink from the ink container 14 to the ink tank 21a and the ink tank 21b become active, the controlling part 16 will predict that the dissolved oxygen amount of the ink is low.

The controlling part 16 can predict the dissolved oxygen amount of the ink in the first ink tank 21a and the second ink tank 21b at the present time, and can also predict the dissolved oxygen amount of the ink in the first ink tank 21a and the second ink tank 21b at the completion of the next printing job.

When actually measuring the dissolved oxygen amount of the ink in the ink tank 21, the controlling part 16 detects bubbles in the ink by air bubble sensors provided in the first degassing channel 31a or the second degassing channel 31b, or the first ink tank 21a or the second ink tank 21b, and the controlling part 16 may actually measure the dissolved oxygen amount of the ink in the ink tank 21 on the basis of the detection results. For example, the controlling part 16 may actually measure the dissolved oxygen amount of the ink in the ink tank 21 on the basis of the detection result of the bubble sensor when the printer 1 is turned on or after the printer 1 is left for a long time (e.g., when printing has not been performed for a predetermined time or longer). As the bubble sensor, any type of sensor, such as photoelectric type, capacitance type, ultrasonic type and others may be applied.

For example, a photoelectric bubble sensor consists of a transmitter that sends a beam and a receiver that receives the beam, and sends the beam from one side of the inside of the first degassing channel 31a or the second degassing channel 31b, or the first ink tank 21a or the second ink tank 21b, and receives the beam on the other side. The photoelectric bubble sensor confirms presence of the bubbles according to received signal of the beam on the basis of change in the received signal of the beam when the beam is blocked by ink or bubbles.

The capacitance type bubble sensor consists of a detection electrode and a ground electrode insulated from each other, and the detection electrode is placed on one side of the inside of the first degassing channel 31a or the second degassing channel 31b, or the first ink tank 21a or the second ink tank 21b, and the ground electrode is placed on the other side. The capacitive bubble sensor detects a state of the bubbles in the ink according to change in capacitance generated between the detection electrode and the ground electrode. The capacitive bubble sensor can be applied to the first degassing channel 31a and the second degassing channel 31b, which are made of a wider range of materials and diameters than the photoelectric bubble sensor. In addition, the capacitive bubble sensors are a cost-effective method for bubble detection because they are constructed at a lower cost than ultrasonic bubble sensors.

The ultrasonic type bubble sensor consists of a generating part, such as a transducer, that generates ultrasonic waves and a receiving part, such as a transducer, that receives ultrasonic waves, and generates ultrasonic waves from one side of the inside of the first degassing channel 31a or the second degassing channel 31b or the first ink tank 21a or the second ink tank 21b, and receives the ultrasonic waves at the other side. Then, using the characteristic that ultrasonic waves pass through liquid while they cannot pass through bubbles and are reflected, the ultrasonic bubble sensor confirms the presence of the bubbles according to signal strength of the received ultrasonic waves. The ultrasonic bubble sensors are applicable to the first degassing channel 31a and the second degassing channel 31b, which have narrow diameters, and are also suitable for detecting microbubbles in the ink, and can provide more accurate measurements than the photoelectric bubble sensor or the capacitive bubble sensor.

Incidentally, the controlling part 16 may use either one of the predicted result and the actual measured result of the dissolved oxygen amount of the ink in the first ink tank 21a and the second ink tank 21b as the measurement result, or a combination of the predicted result and the measured result.

### <Degassing Tank Selection>

Next, degassing tank selection of the ink supplying mechanism 20 in the printer 1 of the embodiment by the controlling part 16 will be described.

When one ink tank 21 among the plurality of ink tanks 21 is used for printing as the print use tank and there are several other ink tanks 21 that are standby tanks whose dissolved oxygen amount of the ink has not arrived the predetermined supplying target value, the controlling part 16 selects the degassing tank to be degassed from these several other ink tanks 21 according to the predetermined degassing selection criteria. For example, the controlling part 16 decides that the supplying target value has not been arrived when the dissolved oxygen amount of the ink in the ink tank 21 exceeds a predetermined supplying oxygen value. If there is one other ink tank 21 whose dissolved oxygen amount of the ink has not arrived the supplying target value, the controlling part 16 may select that other ink tank 21 as the degassing tank regardless of the degassing selection criteria.

Then, in a state that the inside of the ink tank 21 being the degassing tank satisfying the degassing selection criteria is decompressed by the decompressing part (the decompression pump 22 and, the first decompression channel 26a and the second decompression channel 26b), the controlling part 16 circulates the ink inside the degassing tank using the degassing channels (the first degassing channel 31a and the second degassing channel 31b) to perform the degassing operation for degassing the ink inside the degassing tank. After starting the degassing operation of the degassing tank, the controlling part 16 terminates the degassing operation when the dissolved oxygen amount of the ink in the degassing tank becomes less than the predetermined supplying oxygen amount value and satisfies the predetermined supplying target value.

The controlling part 16 performs the degassing tank selection during printing using one ink tank 21 being the print use tank or during printing standby, for example, measures the oxygen dissolved amount of the ink of the other ink tank 21 by prediction and/or actual measurement for example, periodically at predetermined time intervals or at the timing of a print job (start timing or end timing) to perform the degassing tank selection. If the dissolved oxygen amount of the ink in the degassing tank exceeds the predetermined supplying oxygen value due to a prolonged period of printing standby elapsed after completion of the degassing operation of the selected degassing tank, the controlling part 16 may perform the degassing operation of the degassing tank again.

For example, the controlling part 16 may set degassing order for degassing the plurality of ink tanks 21 in advance as the degassing selection criteria, and select the ink tanks 21 as degassing tanks according to the degassing order. In other words, the controlling part 16 selects the ink tank 21 that has arrived in the degassing order as the ink tank 21 that satisfies the degassing selection criteria.

Alternatively, the controlling part 16 may select, as the degassing selection criteria, the ink tank 21, whose dissolved oxygen amount of the ink is predicted to arrive the supplying target value most quickly by the degassing operation, as the degassing tank among the other ink tanks 21 being standby tanks. In other words, the controlling part 16 selects the ink tank 21 whose dissolved oxygen amount of the ink arrives the supplying target value most quickly as the ink tank 21 satisfying the degassing selection criteria. Thereby, it is possible to more quickly prepare the ink tank 21 to be prepared for use in the next printing.

Alternatively, the controlling part 16 may select the ink tank 21 with the highest ink capacity among the other ink tanks 21 being standby tanks as the degassing selection criteria. In other words, the controlling part 16 selects the ink tank 21 with the highest ink capacity as the ink tank 21 satisfying the degassing selection criteria. Thereby, it is possible to prepare ink tank 21 that can be used for a longer period of time.

### <Switching Tank Selection>

Next, the switching tank selection of the ink supplying mechanism 20 in the printer 1 of the embodiment by the controlling part 16 will be described.

When one ink tank 21 among the plurality of ink tanks 21 is used for printing as the print use tank and there are several other ink tanks 21 being standby tanks whose dissolved oxygen amount of the ink has arrived the predetermined supplying target value, the controlling part 16 selects the switching tank to be switched after the one ink tank 21 from these several other ink tanks 21 according to the predetermined switching selection criteria. For example, the controlling part 16 decides that the supplying target value has been arrived when the dissolved oxygen amount of the ink in the ink tank 21 is the predetermined supplying oxygen value or less. Incidentally, if there is only one other ink tank 21 whose dissolved oxygen amount of the ink has arrived the supplying target value, the controlling part 16 may select this other ink tank 21 as the switching tank regardless of the switching selection criteria.

The controlling part 16 performs the switching tank selection when the need arises to switch the one ink tank 21 being the print use tank to the other ink tank 21 being the standby tank. For example, the controlling part 16, periodically at predetermined time intervals or at the timing of a print job (start timing or end timing) during printing using the one ink tank 21 being the print use tank or during standby printing, measures the ink remaining amount and/or the dissolved oxygen amount of the ink in the print use tank by prediction and/or actual measurement. The controlling part 16 performs the switching tank selection when the ink remaining amount in the one ink tank 21 becomes low and approaches the predetermined switching target value, or when the dissolved oxygen amount of the ink becomes high and approaches the predetermined switching target value. For example, the controlling part 16 decides that the switching target value has been arrived when the ink remaining amount is a predetermined switching remaining value or less, and when the dissolved oxygen amount of the ink is a predetermined switching oxygen value or more.

For example, the controlling part 16 may set a switching order for switching to the plurality of ink tanks 21 in advance as the switching selection criteria, and select the ink tank 21 as the switching tank according to the switching order. In other words, the controlling part 16 selects the ink tank 21 that has arrived in the switching order as the ink tank 21 that satisfies the switching selection criteria.

Alternatively, the controlling part 16 may select, as the switching tank, the ink tank 21, which is predicted to take the longest time until the dissolved oxygen amount of the ink arrives the predetermined switching target value when used for printing, as the switching tank among the other ink tanks 21 being the standby tanks. In other words, the controlling part 16 selects the ink tank 21 whose dissolved oxygen amount of the ink arrives the switching target value most slowly as the ink tank 21 that satisfies the switching selection criteria. Thereby, it is possible to use the ink tank 21 longer when the selected switching tank is switched as the next print use tank, and to restrain time and effort required for subsequent switching of the ink tank 21.

Moreover, the controlling part 16 determines whether or not to perform the refilling operation of the standby tank on the basis of the ink remaining amount and the dissolved oxygen amount of the ink in the standby tank measured by prediction and/or actual measurement during printing or standby printing. Incidentally, the controlling part 16 calculates a refilling time required for the refilling operation and a degassing time required for the degassing operation on the basis of the ink remaining amount and the dissolved oxygen amount of the ink in the standby tank, and performs the refilling operation and the degassing operation for the ink tank 21 with the shortest total time of the refilling time and the degassing time among the plurality of ink tanks 21 being the standby tanks.

After that, if the dissolved oxygen amount of the ink in the standby tank exceeds the predetermined supplying oxygen value due to a prolonged period of print standby after the completion of the refilling operation and the degassing operation of the standby tank, and the standby tank requires degassing, the controlling part 16 may perform the degassing operation of the standby tank again, or may perform the degassing operation of another standby tank. When the printer 1 is in print standby, the controlling part 16 may perform the degassing operation of each ink tank 21 as appropriate, depending on the ink remaining amount and/or the dissolved oxygen amount of the ink in each ink tank 21.

### <Example of Operation for Degassing Tank Selection>

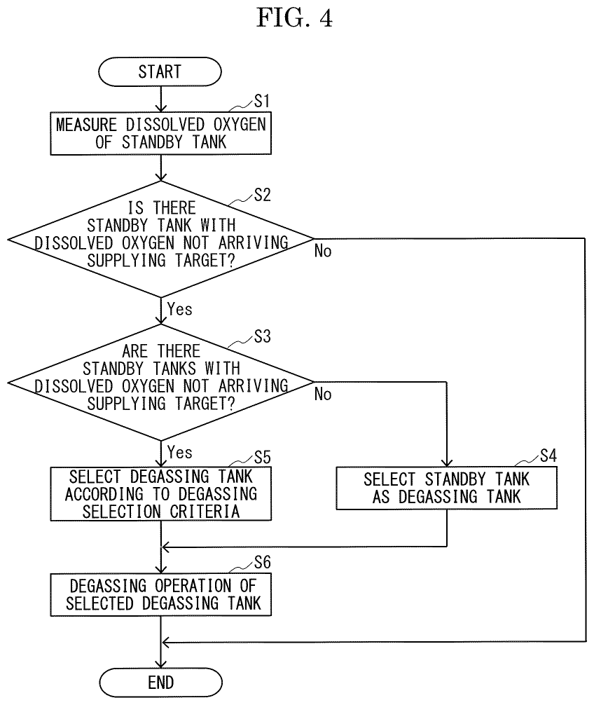

Next, in the printer 1 of the embodiment, an example of the operation of the degassing tank selection will be described with reference to a flowchart of FIG. 4.

When one ink tank 21 among the plurality of ink tanks 21 is used as the print use tank for printing or standby printing, the other ink tanks 21 is used as the standby tank. Then, the controlling part 16 measures the dissolved oxygen amount of the ink in the other ink tanks 21 being the standby tank (step S1). At this time, the controlling part 16 measures the dissolved oxygen amount of the ink in the standby tank at the present time by prediction and/or actual measurement.

The controlling part 16 determines whether or not there is the standby tank whose dissolved oxygen amount of the ink has not arrived the predetermined supplying target value (step S2).

When there is not the standby tank whose dissolved oxygen amount of the ink has not arrived the predetermined supplying target value, that is, the dissolved oxygen amounts of the ink of all the standby tanks have arrived the predetermined supplying target value (step S2: No), the controlling part 16 does not perform the degassing tank selection and does not perform the degassing operation.

On the other hand, when there is the standby tank whose dissolved oxygen amount of the ink has not arrived the predetermined supplying target value (step S2: Yes), the controlling part 16 determines whether or not there are a plurality of standby tanks whose dissolved oxygen amounts of the ink have not arrived the predetermined supplying target value (step S3).

When there is one standby tank whose dissolved oxygen amount of the ink has not arrived the predetermined supplying target value (step S3: No), the controlling part 16 selects this standby tank as the degassing tank (step S4).

On the other hand, when there are a plurality of standby tanks whose dissolved oxygen amounts of the ink have not arrived the predetermined supplying target value (step S3: Yes), the controlling part 16 selects the degassing tank to be degassed from those standby tanks according to the predetermined degassing selection criteria (step S5).

The controlling part 16 performs the degassing operation for the selected degassing tank described above (step S6).

### <Example of Operation for Switching Tank Selection>

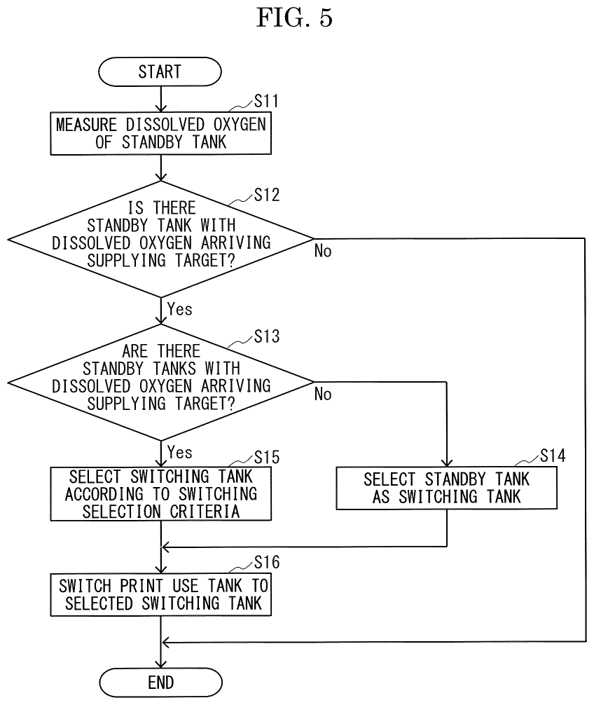

Next, in the printer 1 of the embodiment, an example of the operation of the switching tank selection will be described with reference to a flowchart of FIG. 5.

When one ink tank 21 among the plurality of ink tanks 21 is used as the print use tank for printing or standby printing, the other ink tanks 21 is used as the standby tank. Then, when the need arises to switch the one ink tank 21 being the print use tank to the other ink tank 21 being the standby tank, the controlling part 16 measures the dissolved oxygen amount of the ink in the standby tank (step S11). At this time, the controlling part 16 measures the dissolved oxygen amount of the ink in the standby tank at the present time by prediction and/or actual measurement.

The controlling part 16 determines whether or not there is the standby tank whose dissolved oxygen amount of the ink has arrived the predetermined supplying target value (step S12).

When there is not the standby tank whose dissolved oxygen amount of the ink has arrived the predetermined supplying target value, that is, the dissolved oxygen amounts of the ink of all the standby tanks have not arrived the predetermined supplying target value (step S12: No), the controlling part 16 does not perform the switching tank selection and performs the degassing tank selection described above and performs the degassing operation.

On the other hand, when there is the standby tank whose dissolved oxygen amount of the ink has arrived the predetermined supplying target value (step S12: Yes), the controlling part 16 determines whether or not there are a plurality of standby tanks whose dissolved oxygen amounts of the ink have arrived the predetermined supplying target value (step S13).

When there is one standby tank whose dissolved oxygen amount of the ink has arrived the predetermined supplying target value (step S13: No), the controlling part 16 selects this standby tank as the switching tank (step S14).

On the other hand, when there are a plurality of standby tanks whose dissolved oxygen amounts of the ink have arrived the predetermined supplying target value (step S13: Yes), the controlling part 16 selects the switching tank to be switched from those standby tanks according to the predetermined switching selection criteria (step S15).

The controlling part 16 switches the print use tank to the selected switching tank described above (step S16).

As described above, the ink supplying mechanism 20 provided in the printer 1 is equipped with the ink container 14, the ink tank 21, the decompressing part (the decompression pump 22 and, the first decompression channel 26a and the second decompression channel 26b), and the degassing channels (the first degassing channel 31a and the second degassing channel 31b). The ink container 14 contains the ink. The ink tank 21 stores the ink supplied from the ink container 14 to the recording head 13. The decompressing part decompresses the inside of the ink tank 21. The degassing channel circulates the ink flowed out from the ink tank 21 and flows into the ink tank 21. In the ink supplying mechanism 20, the plurality of ink tanks 21 are arranged in parallel to the recording head 13. When one ink tank 21 among the plurality of ink tanks 21 is used for printing, the ink supplying mechanism 20 selects the degassing tank to be degassed from the other ink tanks 21, whose dissolved oxygen amount of the ink have not arrived the predetermined supplying target value, according to the predetermined degassing selection criteria, and circulates the ink inside the degassing tank using the degassing channel, in a state that the inside of the degassing tank is decompressed by the decompressing part, to perform the degassing operation of degassing the ink inside the degassing tank.

Therefore, the ink supplying mechanism 20 can complete degassing in a shorter time by applying the circulating degassing method than by applying the agitation degassing method. In addition, while printing is being performed using one ink tank 21, by degassing the other ink tank 21, it is possible to immediately switch to the other ink tank 21 when it becomes necessary to switch one ink tank 21. At this time, there is no need to wait for the degassing operation, and printing efficiency can be improved. Moreover, if there are a plurality of other ink tanks 21, by according to the degassing selection criteria, it is possible to appropriately select the degassing tank to be degassed. Thus, according to the present disclosure, the ink tank 21 can be efficiently degassed even when the ink filling volume of the ink tank 21 is increased.

In the embodiment, the ink supplying mechanism 20 decides that the ink tank 21 whose dissolved oxygen amount of the ink arrives the supplying target value most quickly by the degassing operation satisfies the degassing selection criteria for selecting the degassing tank.

Therefore, it is possible to complete the degassing operation of the degassing tank more quickly, and then, to prepare the ink tank 21 used for the next printing more quickly.

In the embodiment, the ink supplying mechanism 20 decides that the ink tank 21 with the highest ink capacity satisfies the degassing selection criteria for selecting the degassing tank.

Therefore, it is possible to prepare the ink tank 21 that can be used for a longer period of time, by completing the degassing operation of the ink tank 21 with the higher ink capacity.

In the embodiment, the ink supplying mechanism 20 selects, when one ink tank 21 among the plurality of ink tanks 21 is used for printing, the switching tank to be switched after the one ink tank 21 from the other ink tanks 21 whose dissolved oxygen amount of the ink has arrived the predetermined supplying target value, according to the predetermined switching selection criteria.

Therefore, when there are a plurality of other ink tanks 21, it is possible to appropriately select the switching tank to be switched in place of the print use tank by according to the switching selection criteria. Then, it is possible to smoothly perform switching of the ink tank 21, thereby improving the printing efficiency.

In the embodiment, the ink supplying mechanism 20 decides that the ink tank 21, which is predicted to take the longest time until the dissolved oxygen amount of the ink arrives the predetermined switching target value when used for printing, satisfies the switching selection criteria for selecting the switching tank.

Therefore, when the selected switching tank is switched to the next print use tank, it is possible to use the ink tank 21 longer, and then to restrain time and effort required for subsequent switching of the ink tank 21.

In the embodiment, the ink supplying mechanism 20 is equipped with the degassing pump 24 common to the plurality of ink tanks 21 in the degassing channel, and the degassing operation of each of the plurality of ink tanks 21 is performed by using the degassing pump 24.

Therefore, since there is no need to provide the degassing pump 24 for each of the plurality of ink tanks 21, it is possible to improve space efficiency. Incidentally, in order to suppress degassing noise, the degassing operation is performed for each one of the plurality of ink tanks 21, but the degassing operation is not performed for the plurality of ink tanks 21 simultaneously.

In the embodiment described above, an example that the ink supplying mechanism 20 is equipped with the degassing channels (the first degassing channel 31a and the second degassing channel 31b) and the degassing pump 24 for the ink tanks 21 to circulate the ink flowed out from the ink tanks 21 and flow the ink into the ink tanks 21, thereby degassing the ink tanks 21 has been described, the present disclosure is not limited to this example. In the present disclosure, the ink supplying mechanism 20 may be configured to be equipped with degassing channels and a degassing pump for the ink container 14 to circulate the ink flowed out from the ink container 14 and flow the ink into the ink container 14, thereby degassing the ink container 14.

The present disclosure is not limited to the configuration of the embodiments described above for the printer 1 and the ink supplying mechanism 20, and the printer 1 and the ink supplying mechanism 20 may be configured with different specifications and combinations of operations according to usage environment. Therefore, it is possible to perform the optimal degassing operation according to condition of the printer 1, thereby reducing downtime of the printer 1.

Although the embodiment has been described about a case where a configuration of the present disclosure is applied to the printer 1 as the image forming apparatus, in another embodiment, the configuration of the present disclosure may be applied to another image forming apparatus, such as a copying machine, a facsimile or a multifunction peripheral, as long as it is equipped with the inkjet type ink supplying mechanism.

1. An ink supplying mechanism comprising:
an ink container containing ink;
an ink tank storing the ink supplied from the ink container to a recording head;
a decompressing part decompressing the inside of the ink tank; and
a degassing channel circulating the ink flowed out from the ink tank and flowing the ink into the ink tank,
wherein, to the recording head, a plurality of the ink tanks are arranged in parallel,
when one ink tank among the plurality of ink tanks is used for printing, a degassing tank to be degassed is selected from other ink tanks, whose dissolved oxygen amount of the ink have not arrived a predetermined supplying target value, according to predetermined degassing selection criteria, and the ink inside the degassing tank is circulated by using the degassing channel, in a state that the inside of the degassing tank is decompressed by the decompressing part, to perform degassing operation of degassing the ink inside the degassing tank.

2. The ink supplying mechanism according to claim 1, wherein
it is decided that the ink tank whose dissolved oxygen amount of the ink is predicted to arrive the supplying target value most quickly by the degassing operation satisfies the degassing selection criteria for selecting the degassing tank.

3. The ink supplying mechanism according to claim 1, wherein
it is decided that the ink tank with the highest ink capacity satisfies the degassing selection criteria for selecting the degassing tank.

4. The ink supplying mechanism according to claim 1, wherein
when one ink tank among the plurality of ink tanks is used for printing, a switching tank to be switched after the one ink tank is selected from other ink tanks whose dissolved oxygen amount of the ink has arrived the predetermined supplying target value, according to predetermined switching selection criteria.

5. The ink supplying mechanism according to claim 4, wherein
it is decided that the ink tank, which is predicted to take the longest time until the dissolved oxygen amount of the ink arrives a predetermined switching target value when used for printing, satisfies the switching selection criteria for selecting the switching tank.

6. The ink supplying mechanism according to claim 1 comprising:
a degassing pump common to the plurality of ink tanks in the degassing channel,
wherein the degassing operation of each of the plurality of ink tanks is performed by using the degassing pump.

7. An image forming apparatus comprising:
the ink supplying mechanism according to claim 1.
